(19) United States
(12) Patent Application Publication
(10) Pub. No.: US 2004/0244654 A1
(43) Pub. Date: Dec. 9, 2004

(54) Additives for cement compositions

(76) Inventors: Mickael Allouche, Paris (FR); Pierre Maroy, Saint Galmier (FR)

Correspondence Address: SCHLUMBERGER TECHNOLOGY CORPORATION, IP DEPT., WELL STIMULATION, 110 SCHLUMBERGER DRIVE, MD1, SUGAR LAND, TX, 77478, US

(21) Appl. No.: 10/486,878

(22) PCT Filed: Jul. 22, 2002
(86) PCT No.: PCT/EP02/08198

(30) Foreign Application Priority Data
Aug. 13, 2001 (FR) 0110869

(51) Int. Cl. C08L 1/00; C08J 3/00; C08K 3/00

(52) U.S. Cl. 106/808; 106/727; 106/823; 524/5

(57) ABSTRACT

An additive for use in aqueous cement slurries which adapted such that, when added to an aqueous cement slurry, it migrates to an interface between the slurry and an adjacent solid material or fluid composition during a setting phase of the cement because of the passing of the upper limit of solubility in the water of the additive.

The present invention relates to additives for cement systems. In particular, the invention provides additives and cement compositions in which the behaviour of the cement at an interface is modified or controlled.

Additives are used in cement compositions in order to modify either the properties of the fluid before it sets, and therefore in the fluid or liquid state, or the properties of the cement fluid after it sets. Such additives are used in the field of construction, building and civil engineering, and in the cement industry and in the construction and repair of oil wells. their applications are very numerous, and include:

Dispersing agents (also known as plasticisers in the fields of construction or building and civil engineering): used for reducing the viscosity of the fluid or to increase its workability.

Retarders or accelerators: used for increasing or reducing the time taken for the cement to set, or the time during which the cement slurry remains workable.

Air entrainers: intended to trap the fine bubbles of gas in the cement slurry.

Foaming agents: used in preparing foamed cements.

Stabilisers: used for preventing the sedimentation of particles in suspension or the appearance of a layer of free water on top of the cement column.

Antifoaming and “foam destruction” agents (“defoamers”): used for reducing the quantity of air trapped in clinker cements.

Additives for expansion or dilatation: the hydration of the cement during setting and during the hardening period results in an overall reduction in the volume which is referred to as “bulk shrinkage”. Such additives are used for preventing this bulk shrinkage or for causing an expansion of the cement.

Agents for improving compressive strength: microsilica or a microcement.

Agents for improving the resistance of the hardened cement [symbol] set) to high temperatures. At temperatures greater than 110 [symbol] undergoes a crystalline change. The new crystalline species [symbol] result in a reduction of the compressive strength and to an increase in permeability. Additives are then used for preventing this crystalline modification or for orienting the modification to different crystalline species.

All of the above properties are bulk cement properties. The additives are therefore added to the slurry, where they are dissolved or dispersed and they therefore act on the total volume of the cement composition.

There are other properties which are related to the surface of the cement. The surface (interface) can exist either between the mass of the cement and the medium adjoining the cement, such as rock, steel, plastics material, or various fluids, or between the mass of cement and solid materials added to the cement which are not of the same nature as the cement, such as fibres, platelets or particles/agglomerates). Additives for controlling such properties include:

Fluid loss control additives (also known as water retention additives in the building and civil engineering industry). These additives are used for maintaining the mixture water in the mass of slurry by virtue of the formation of an impermeable cake at the interface through which the water might otherwise pass, such as the interface with a formation or a porous solid material.

Agents for improving the adhesive properties. These additives can be used for improving the adhesion or adherence to adjoining or adjacent solid materials such as steel, plastics material, rock or geological formations, or particles not belonging to the category of cements, or fibres, incorporated in the cement phase.

In these cases, the additive is only useful at the interface, but, because of the fact that it is added to a fluid or slurry, it dissolves in the total volume of the fluid. This represents a loss of the major part of the additive, which can in some cases present drawbacks with regard to the setting of the cement.

The additives are predominantly polymers with molecular weights situated between low molecular weights (oligomers or plurimers) and very high molecular weights (up to tens of millions).

There is therefore a significant need, in the industries in question, for products or processes for avoiding or eliminating the drawbacks and technical problems indicated above.

The present invention provides additives for use in aqueous cement slurries, the additives being adapted such that, when added to an aqueous cement slurry, they migrate to an interface between the slurry and an adjacent solid material or fluid composition during a setting phase of the cement because of the passing of the upper limit of solubility in the water of the additive.

One objective of the present invention is to design additives which can be dissolved in the mass of the cement slurry, but which are capable of migrating to the interface or boundary when the cement type begins to harden or to set.

According to one embodiment of the present invention, when a polymer is added to an aqueous-base fluid for making up cement, and is used under conditions such that it is substantially at its limit of solubility in water or the aqueous medium in question, it has a tendency to migrate to the boundaries of the said fluid during setting.

The invention therefore relates either to the use of polymers which are very soluble in water or an aqueous medium, but at their upper limit of solubility in water, or a polymer with less good or poor solubility in water, also at its upper limit of solubility in water. The fundamental criterion according to the invention is that, when the aqueous cement composition sets, the quantity of water used for the setting of the said cement suffices to ensure that the quantity of polymer becomes progressively greater than the limit of solubility of the polymer in the medium, which causes the migration indicated above, to the interface.

It will be understood that the term “upper limit of solubility” also covers the vicinity of this limit, that is to say when the polymer is employed in a quantity corresponding to a value situated slightly below its upper limit of solubility, but that the hydration and setting of the cement and the water absorption which results therefrom are sufficient so that the limit of solubility of the polymer is exceeded, which causes, according to the invention, the migration of the additive in question to the interface.

The quantities and relative proportions of the polymers or other additives in question and the aqueous cement fluid (or other type of fluid based on a cement or an equivalent or comparable hydraulic binder) and other additives can be varied according to the particular case of the operation to be performed and its parameters.

When the fluid containing cement undergoes setting, it uses the interstitial water for hydration. The quantity of water is then reduced and the relative concentration of polymer is thus increased. What is surprising is the fact that the molecules migrate and do not precipitate in the mass, and that the large molecules such as polymers of high molecular weight are capable of migrating.

If the additive comprises a polymer, it is preferably one which is produced by a random cocondensation/copolymerisation. If the polymer chains carry particular functional groups designed to supply the required properties in the interface, when the polymer moves to the boundaries of the mass during setting, it transports these functional groups to the point at which they will act. These functional groups can be fixed to the polymer chain by grafting, or they can be included in the polymer chain by an operation of copolymerisation or cocondensation of monomers carrying such functional groups.

The present invention means that it is necessary to use a much smaller quantity of additives in the bulk cement than previously proposed for which additives are assumed to act, and, if the additives can have harmful effects on the bulk cement, this effects are avoided.

There are many products known for forming cement compositions, such as Portland cement, high-alumina cement, also known as Ciment Fondu, gypsum plaster, lime, magnesium oxychloride cement, materials based on phosphorus-containing derivatives, and products known as pozzolan products, which require activation in order to become products for use in a composition intended to form a cement. Amongst the substances of the pozzolan-type, the following can be used: pozzolan, various types of fly ash and cenospheres, clinkers such as blast furnace clinkers, laterites or clays which have been heat treated, diatomaceous earths, zeolites and small silica particles (below 700 microns). The size of the particles of the material also fulfils a role since small sizes promote the pozzolanic reaction rate, and microcement, microclinker and microsilica can also be used.

The above invention represents a particular advantage in improving the characteristics of the bonding of cement materials to the adjacent or surrounding materials. The type of functional group which is added to promote the bonding can be selected according to the nature of the adjacent or surrounding materials. The functional groups may be may be electron donors or electron acceptors or be ionic or incorporate any special characteristics for promoting the bonding vis-a-vis a given material.

If the polymer is not ionic, the solubility of the polymer can be evaluated according to the size of this polymer when it is dissolved in the interstitial water, that is to say the water containing all the ions released by the materials of the composition for a cement, or by applying the Flory constant. In practice, the easiest way of achieving poor solubility consists in using a copolymer of a monomer which is soluble in water and of a hydrophobic monomer, or grafting a hydrophobic lateral group or hydrophobic pending group onto a hydrophilic skeleton, or grafting a hydrophilic lateral group onto a hydrophobic skeleton.

The benefit of the invention can be seen when operating at the “limit of solubility”:

In the case of a random copolymerisation, the proportion of hydrophobic monomers is improved up to a point situated just below the point where the polymer is no longer soluble.

If hydrophilic grafts are added to a hydrophobic skeleton, the grafting proportion is progressively reduced to a value situated just above the point where the polymer becomes insoluble.

With hydrophobic grafts placed on a hydrophilic skeleton, the procedure is precisely the reverse of the previous one. If the hydrophobic grafts are alkyl chains, chains shorter than C10 will be chosen in order to avoid obtaining associative properties, if these are not sought, in addition to the migration properties described in the present application.

The present invention can be applied to any cementing operation, including in the field of construction or building or civil engineering, and in the construction and cementing of oil wells. The present invention is very useful for all types of repair operations using materials making [symbol] compositions in the above industrial fields. The present invention has [symbol] in the case of the abandonment and plugging of gas or oil or geothermic wells (“P&A”), and similar operations.

The invention also relates to a method for using cement compositions containing additives as described above, in particular of the polymer type, in any cementing operation, including in the field of construction or building or civil engineering, and in the construction and cementing of oil, gas or geothermic wells and in the case of the abandonment and plugging of gas or oil or geothermic wells (“P&A”), characterised in that at least one polymer is added to an aqueous-based fluid for making up cement), and is used under conditions such that it is situated substantially at its limit of solubility in water or the aqueous medium in question, with migration to the boundaries of the said fluid during setting.

The invention also relates to a method as described above, characterised in that use is made of either one or more polymers which are very soluble in water or an aqueous medium, but at their upper limit of solubility in water, or one or more polymers with less good or poor solubility in water, also at its upper limit of solubility in water.

The invention also relates to a method as described above, characterised in that, during the setting of the aqueous composition of cement, the quantity of water used for the setting of the cement suffices to ensure that the quantity of the polymer or polymers becomes greater than the limit of solubility of the polymer or polymers in the medium, which causes the migration of the polymer or polymers to the interface.

### EXAMPLE 1

Use is made in this example of a random copolymer of the following type:

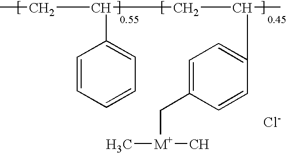

The degree of polymerisation is approximately 70. This copolymer is perfectly soluble in water.

A cement slurry is prepared using 795 grams of class G Portland cement (Dyckerhoff North™), 344 grams of water and 0.86 grams of the above copolymer. The slurry is mixed according to the API (“American Petroleum Institute”) standards. Some of the slurry is placed in a closed glass beaker. After the cement sets, it is impossible to remove the cement. When the beaker is broken, the pieces of the beaker remain stuck to the block of cement. The pieces of glass have to be removed by means of a spatula. The faces of the cement situated facing the glass have a shiny and glossy appearance. The face of the cement facing the air, as well as the inside of the block of cement, has an appearance identical to that of a conventional cement. Because of the cationic sites introduced, the polymer has an affinity with the silicate contained in the glass. On the other hand there is no special affinity with the air.

### EXAMPLE 2

Use is made in this example of a random copolymer of vinyl acetate and vinylpyrrolidone of the following formula:

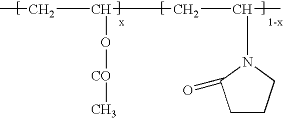

in which x is equal to 35.6%. The molecular weight is approximately 30,000. The polymer is a product sold by the company GAP.

A clinker cement is prepared using 793 grams of class G Portland cement (Dyckerhoff North™), 342 grams of water and 7 grams of the above copolymer. This clinker is n. accordance with API standards.

Some of the clinker is poured onto a tile or onto an iron plate. After the clinker sets, the cement adheres strongly to the metallic surface or to the smooth tile. It can be removed only by scraping by means of a strong spatula. The interfaces of the cement with the surface of the tile or metal and with the air are shiny and glossy. The inside of the block of cement has an appearance identical to that of a conventional cement. In this second example, the polymer has also migrated to the interface between the air and the cement, since it has better affinity with the air.

### EXAMPLE 3

The polymer in this example is of the same type as that of Example 2, except that x is equal to 46%. The molecular weight is approximately 30,000. The polymer is also a product sold by the company GAP, Two clinker cements are prepared, using 288 grams of water, one gram of an antifoaming agent sold by Schlumberger under the name D47, 6 grams of a dispersing agent sold by Schlumberger under the name D80, 968.6 grams of a class H Lafarge cement and 18.9 grams of carbon fibre. These “pitch” carbon fibres, of category KCF 100 code C103T, are produced by the Kuhera Chemical Industry Co. The second clinker has the same composition as the first clinker, except that the polymer is added, at the rate of 2% by weight with respect to the fibres. The polymer is the one described in Example 2, with a value x=46%. This polymer is produced by the company GAP and is sold under the name PVPNA S-630.

The setting of the cement is effected over 24 hours at 27° C. A good method for measuring the adhesion between the fibres and the cement consists in breaking a cement sheet and then measuring the mean length of the broken fibres projecting beyond the fracture line, since this represents substantially half the distance at which the tension is transmitted.

Photographs under an electron microscope show that, without the polymer, the fibres project by approximately 200 microns When the small addition of polymer is made, the fibres project no more than 100 microns.

### EXAMPLE 4

Two different clinker cements are prepared. The clinker of reference A has the following composition: 257.59 grams of water, 0.74 grams of a fluid loss control agent (product named D167 sold by Schlumberger), 3.97 grams of a liquid dispersing agent of the polynaphthalenesulphonate type (D080, sold by Schlumberger), 2.21 grams of a setting accelerator of the silicate type (D75 sold by Schlumberger™), 1.59 grams of a antifoating agent (D175 sold by Schlumberger), 148.43 grams of a microcement (product Spinor A12, sold by Ciments d'Origny), 138.37 grams of coarse cenospheres (fly ash) and 75.47 grams of small cenospheres (fly ash).

The second clinker, called B, is identical to clinker A except that 5.2 grams of a random copolymer of vinylpyrrolidone and vinyl acetate is added. The polymer is of the same type as in Example 3, with x equal to 46%. The polymer is supplied by the company Sigma. The two clinkers are poured into moulds formed by a stainless steel plate and a cylinder made from polyvinyl chloride (PVC). The PVC sleeve is attached to the plate by means of a small quantity of silicone gel in order to prevent leakage of clinker. In the two moulds, the clinker cement is left under setting conditions at room temperature for 48 hours. After the cement sets, a microspace appears along the PVC edges in the case of composition A. This is a miniscule crack, with a width less than ¼ mm. Nevertheless, the cement plug would produce a leakage if a pressure were applied to its top. With composition B, there are no microannular spaces and a cement plug would have been impervious.

After elimination of the traces of silicon joint around the PVC cylinder, there is practically no adhesion of the cement composition A to the steel plate. Only a small thin surface (approximately 0.1 mm) has formed and the block has very easily been removed from the plate. It was possible to slide the block of cement out of the sleeve. On the other hand, with the mould filled with composition B, it was extremely difficult to separate the sleeve from the plate. The cement finally broke in bulk, leaving on the plate a uniform layer of cement (thickness greater than 4 mm), stuck to this plate.

After rupture, it was difficult to inject air into the sleeve in order to completely separate the plate from the PVC sleeve. Attempts were made to remove the cement plate adhering to the stainless steel plate, using a metallic plate in order to attempt to remove it by scraping. The small sheet of cement of composition A was removed easily: it separated in the form of sheets. With composition B containing the polymer, no cement sheet separated. Small edges of the mass of cement even remained stuck to the plate between the scraped places.

1-14. delete.

15. An additive for use in aqueous cement slurries, said additive,
being adapted such that, when added to an aqueous cement slurry, it migrates to an interface between the slurry and an adjacent solid material or fluid composition during a setting phase of the cement because of the passing of the upper limit of solubility in the water of the additive; and
comprising one or more polymers comprising randomly co-polymerised functional units of the following formula: 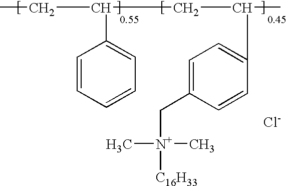
in which the degree of polymerisation is approximately 70, the copolymer being soluble in water, the limit of water solubility of the polymer being such that the absorption of water which results from the setting of the cement causes the polymer to become at least partially insoluble in water and to migrate to the interface.

16. The additive of claim 15, wherein the functional units are electron donors, electron acceptors, ionic or incorporate characteristics for promoting bonding vis-a-vis the solid material or adjacent fluid composition.

17. The additive of claim 15, wherein the polymer has poor solubility in water and comprises a copolymer of a water-soluble monomer and a hydrophobic monomer, a polymer having hydrophobic lateral functional groups or hydrophobic pendant functional groups grafted onto a hydrophilic skeleton, or a polymer comprising hydrophilic lateral functional groups grafted onto a hydrophobic skeleton.

18. The additive of claim 17, comprising a random copolymer having a proportion of hydrophobic monomers just below a level at which the polymer is no longer soluble in water.

19. The additive of claim 17, comprising a polymer having hydrophilic grafts on a hydrophobic skeleton, the proportion of hydrophilic grafts being at a value situated just above a level at which the polymer becomes insoluble in water.

20. The additive of claim 17, comprising a polymer having hydrophobic grafts on a hydrophilic skeleton, the proportion of hydrophobic grafts being at a value situated just below a level at which the polymer becomes insoluble in water.

21. The additive of claim 20, wherein the hydrophobic grafts are alkyl chains shorter than C10.

22. An additive for use in aqueous cement slurries, said additive,
being adapted such that, when added to an aqueous cement slurry, it migrates to an interface between the slurry and an adjacent solid material or fluid composition during a setting phase of the cement because of the passing of the upper limit of solubility in the water of the additive; and
comprising one or more polymers comprising random copolymers of vinyl acetate and vinyl pyrrolidone of the following formula: 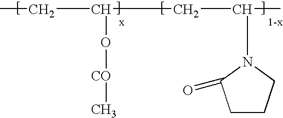
wherein x=0.356 or 0.46, the polymer having a molecular weight of approximately 30,000, the copolymer being soluble in water, the limit of water solubility of the polymer being such that the absorption of water which results from the setting of the cement causes the polymer to become at least partially insoluble in water and to migrate to the interface.

23. The additive of claim 22, wherein the functional units are electron donors, electron acceptors, ionic or incorporate characteristics for promoting bonding vis-a-vis the solid material or adjacent fluid composition.

24. The additive of claim 22, wherein the polymer has poor solubility in water and comprises a copolymer of a water-soluble monomer and a hydrophobic monomer, a polymer having hydrophobic lateral functional groups or hydrophobic pendant functional groups grafted onto a hydrophilic skeleton, or a polymer comprising hydrophilic lateral functional groups grafted onto a hydrophobic skeleton.

25. The additive of claim 24, comprising a random copolymer having a proportion of hydrophobic monomers just below a level at which the polymer is no longer soluble in water.

26. The additive of claim 24, comprising a polymer having hydrophilic grafts on a hydrophobic skeleton, the proportion of hydrophilic grafts being at a value situated just above a level at which the polymer becomes insoluble in water.

27. The additive of claim 24, comprising a polymer having hydrophobic grafts on a hydrophilic skeleton, the proportion of hydrophobic grafts being at a value situated just below a level at which the polymer becomes insoluble in water.

28. The additive of claim 27, wherein the hydrophobic grafts are alkyl chains shorter than C10.

29. A cement composition comprising:
a) cement;
b) water; and
c) an additive as claimed in claim 15.

30. The composition of claim 29, wherein the cement comprises Portland cement, high-alumina cement, gypsum plaster, lime, magnesium oxychloride cement, materials based on phosphorus-containing derivatives, pozzolans, fly ash, cenospheres, clinkers, heat-treated clays, diatomaceous earths or zeolites.

31. The composition of claim 29, wherein the cement comprises microcement, microclinker or microsilica.

32. A method of bonding including the step of pumping a cement including an additive as in claim 15 in order of achieving improved bonding characteristics of cement to adjacent or surrounding materials.

33. The method of claim 32, wherein the cementing operation is in the field of construction or building and civil engineering, or in the construction and cementing of oil, gas or geothermic wells.

34. The method of claim 32, wherein the step of pumping a cement is performed for construction, plugging or abandonment, or remediation operations of oil, gas or geothermic wells.

35. A cement composition comprising:
d) cement;
e) water; and
f) an additive as claimed in claim 22.

36. The composition of claim 35, wherein the cement comprises Portland cement, high-alumina cement, gypsum plaster, lime, magnesium oxychloride cement, materials based on phosphorus-containing derivatives, pozzolans, fly ash, cenospheres, clinkers, heat-treated clays, diatomaceous earths or zeolites.

37. The composition of claim 35, wherein the cement comprises microcement, microclinker or microsilica.

38. A method of bonding including the step of pumping a cement including an additive as in claim 22 in order of achieving improved bonding characteristics of cement to adjacent or surrounding materials.

39. The method of claim 38, wherein the cementing operation is in the field of construction or building and civil engineering, or in the construction and cementing of oil, gas or geothermic wells.

40. The method of claim 38, wherein the step of pumping a cement is performed for construction, plugging or abandonment, or remediation operations of oil, gas or geothermic wells.
